(19) United States
(12) Patent Application Publication
(10) Pub. No.: US 2014/0267550 A1
(43) Pub. Date: Sep. 18, 2014

(54) METHOD AND SYSTEM FOR AN IMPROVED VIRTUAL BREAKOUT ROOM

(71) Applicant: POLYCOM, INC., San Jose, CA (US)

(72) Inventors: Alain Nimri, Austin, TX (US); Jonathan Gallmeier, Austin, TX (US)

(21) Appl. No.: 14/210,117

(22) Filed: Mar. 13, 2014

Related U.S. Application Data
(60) Provisional application No. 61/784,444, filed on Mar. 14, 2013.

(51) Int. Cl. H04N 7/15

(52) U.S. Cl. CPC H04N 7/152
USPC 348/14.03; 348/14.09

(57) ABSTRACT

Management and display of virtual breakout rooms in a video teleconference by making the virtual experience to more closely align the beneficial capabilities of non-virtual breakout rooms is disclosed. Beneficial aspects include summoning all members of a breakout rooms by video, text, or audio signal and a process of assigning participants to a break out room by drag and drop from a roster, randomizing the assignments, and limiting rooms to a particular number of participants to as to cause participants to scramble for a position in a breakout room. Also disclosed is a system for designating a private breakout room and for delivering content to the breakout room.

### RELATED APPLICATION DATA

This Application claims priority to Provisional U.S. Patent Application Ser. No. 61/784,444 filed Mar. 14, 2013, titled “Automated Video Conference Breakout Rooms,” which is hereby incorporated by reference in its entirety.

### BACKGROUND

A breakout session is where a smaller group of meeting attendees separate from a main group to discuss specific subjects or aspects of a broader or tangentially themed main meeting. Such breakout sessions are common in business meetings and educational settings and are often organized or controlled by a chairperson, presenter, or instructor. These sessions are also generally of a relatively shorter duration than the main meeting and may require a method of calling breakout participants back to the main meeting to resume or conclude the main meeting. When all the participants are physically in the same location such as a main conference room, a breakout session is easily achieved by moving participants to a quiet corner of the room, or by moving participants to another nearby location. In this situation, the presenter or instructor can call the participants back into the room at will.

To assign participants to breakout sessions, the presenter or instructor can also divide participants into groups and assign those groups to different breakout rooms to facilitate breakout session discussions. To accomplish this in a physical conference room, the instructor often divides the room by seating arrangements (e.g., chair rows) or by physical room sections. For example, the instructor may divide the room into two groups by splitting the groups by an imaginary line dividing the room into two halves.

Breakout rooms can also be used to create a diverse participant makeup. In other words, instructors may want to “mix up” participants to break up cliques of participants who are sitting next to people who they are familiar with. Often this is accomplished by “counting off” by assigning each participant a consecutive number counting up from “one” until the desired number of breakout sessions is reached and then beginning again from “one.” However, this method does not necessarily produce sufficiently random results. To make the selections more random, for example, an instructor may pull numbers out of a hat. However, for a large number of participants, this is time consuming and cumbersome.

It is often desirous to limit the length of a breakout session. To accomplish this, a presenter or instructor may tell the participants to return after a predetermined amount of time. Additionally, the presenter or instructor may signal the end of a breakout session by going to each breakout area and call the participants back into the room. This technique is not always effective or efficient as there can be groups or individuals who lag in rejoining the main conference room.

Presenters or instructors also often want to distribute supplementary materials “on the fly” during a breakout session. Such materials are sometimes distributed in this manner to force a group to react to a spontaneous stimulus. Sometimes, the materials themselves are not available prior to a breakout session. Distribution of these materials is generally done by physically delivering the materials to each breakout room and giving brief supplemental information or instruction associated with the supplemental materials.

To create an effective videoconferencing environment, it is usually desirable for a videoconferencing system to emulate what participants would experience during a regular, face-to-face meeting with other participants. This includes having the ability to organize and execute breakout sessions with a particular subset of the participants. Prior art techniques for enabling virtual breakout rooms make it possible for participants to engage in sub-conferences within a video teleconference. Such techniques are described in U.S. Pat. No. 7,679,640 and U.S. Pat. No. 7,679,638, which present systems and methods for conducting a sub-conference from a main videoconference.

### SUMMARY

An improved method of managing videoconference breakout rooms is disclosed. The present disclosure relates, at least, to assigning participants to breakout rooms, summoning participants back to a main videoconference from a breakout session, and providing a display for each breakout session.

A chairperson of a main videoconference may need to assign some or all of the participants of the videoconference to a breakout room to discuss matters relating to the main videoconference. The chairperson can assign participants to breakout rooms in various ways including generating a roster of participants and/or generating a number of breakout rooms based upon characteristics of the participants. Assignments may also be made randomly to provide participant diversity to the breakout rooms. The chairperson can also make those assignments in advance of initiating the breakout session. That is, breakout room designations and assignments can be made a priori and prior to the breakout session. Additionally, the advance assignments may be made during the formation of the main video conference. Assigning participants ahead of time will allow the chairperson to send all breakout room participants to (or recall breakout room participants from) the breakout rooms simultaneously. Also disclosed are methods for limiting the number of participants in a breakout room.

In situations where returning from a breakout room by individual participants is desired, participants may be sent a video, audio, or textual indicator from the chairperson indicating that it is time to return to the main videoconference. A method of summoning breakout room participants back by use of a timer is also disclosed. The timer can be displayed in the breakout session and/or the main videoconference as a visual indicator of the amount of time left in the breakout session. Participant's return from the breakout session can also be set to happen contemporaneously (i.e., at the same time) and automatically when the timer expires.

Additionally, when participants wish to have a private breakout session from the main videoconference. Participants in a private breakout room may select a user interface control button to indicate that their breakout session is private. The private session control can automatically prevent other participants from watching, listening to, or joining the breakout session. An annunciator can be shown on the participant's and the chairperson's display to show that a particular breakout session has become a private session.

The chairperson may also wish to send unique content such as graphs, video, documents, and/or images to breakout rooms for consideration of breakout room participants. Chairpersons may provide content to different break-out sessions, by uploading the content to each breakout room in advance of the breakout room's commencement. The chairperson may choose to send the content by selecting a button on the Chairperson's Interface. The content can also be displayed during the breakout session at times pre-determined by the chairperson.

The foregoing summary is not intended to summarize each potential embodiment or every aspect of the present disclosure, and other features and advantages of the present disclosure will become apparent upon reading the following detailed description of the embodiments with the accompanying drawings and appended claims.

Furthermore, although specific exemplary embodiments are described in detail to illustrate the inventive concepts to a person skilled in the art, such embodiments are susceptible to various modifications and alternative forms. Accordingly, the figures and written description are not intended to limit the scope of the inventive concepts in any manner.

### BRIEF DESCRIPTION OF THE DRAWINGS

FIG. 1 illustrates a high-level block diagram of a videoconferencing system.

FIG. 2 illustrates an exemplary relationship between a main video session and a breakout session.

FIG. 3 illustrates an exemplary implementation of videoconference rooms using an existing calling mechanism.

FIG. 4 illustrates an exemplary main videoconference display for a chairperson of a videoconference conference.

FIG. 5 illustrates an exemplary display for a participant of a breakout room in a videoconference.

FIG. 6 illustrates a display where a chairperson may assign one or more participants to a breakout room.

### DETAILED DESCRIPTION

FIG. 1 schematically illustrates a high-level diagram of a videoconferencing system 100 having a plurality of endpoints 180a-180n, multimedia connections 120a-n, a network 190, and a Multipoint Control Unit (MCU) 150. Multimedia connections 120a-n convey information between endpoints 180a-n and the network 190, and the multimedia connection 125 conveys information between the network 130 and the MCU 150. The information communicated between the endpoints 180a-n and the MCU 150 may include control signals, indicators, audio information, video information, and other data.

Alternative embodiments of the system 100 may include other components and/or may not include all of the components shown in FIG. 1. For example, in one embodiment, the MCU 150 can be a virtual MCU. In some embodiments in which network 190 includes a plurality of MCUs 150, a virtual MCU may be used for controlling the plurality of MCUs. More information on a virtual MCU can be found in U.S. Pat. No. 7,174,365. In some embodiments of system 100, one of the MCUs can perform the functionality of the virtual MCU and may control the rest of the MCUs. Additionally, data associated with the conference need not be stored in the MCU, but may be stored in a network cloud using cloud computing or cloud-based storage.

The described videoconference breakout rooms may be realized in many ways. The videoconference and breakout rooms may be implemented in the form of software used by the MCU 150. Additionally, hardware or firmware may be added to the MCU 150 or software or hardware distributed among the MCU 150 and the videoconference terminals 180. The above description of methods and systems are to be interpreted as including apparatuses for carrying out the methods and methods of using the apparatuses.

Although shown here with three endpoints for simplicity, it is understood that a videoconference may have many endpoints and multimedia connections as indicated by ellipses in FIG. 1. Each endpoint 180a-180n may include one or more participants (not shown). Additionally, some components of the videoconferencing system 100 are well known in the art and are only briefly described herein.

Network 190 may represent a single network or a combination of two or more networks. The network 190 may be any type of network, including a packet switched network, a circuit switched network, and Integrated Services Digital Network (ISDN) network, the Public Switched Telephone Network (PSTN), an Asynchronous Transfer Mode (ATM) network, the Internet, or an intranet. The multimedia communication over the network may be based on any communication protocol including H.120, H.324, H.323, SIP, etc. The information communicated between the endpoints 180 and the MCU 150 may include signaling and control, audio information or video images. The endpoints may provide speech, video, signaling, or control data, or may provide a combination of data types.

Endpoints 180a-180n may be network elements that are able to generate or terminate a multimedia connection. Any combination of endpoints 180a-180n can participate in any given videoconference controlled by the MCU 150. The endpoints 180a-180c may provide or receive audio, video, or other data, or any combination thereof. Accordingly, each endpoint 180a-n may have a speaker, a user control device, a microphone, a camera, a display screen, a multimedia line 120, or any combination of these components. Examples of endpoints 180 include a regular telephone, an IP Phone, a cellular phone (with or without a camera), a personal computer, PDA, computing tablet, and may comprise a multimedia endpoint like a Polycom® RealPresence® group series device, etc. The following description assumes that the main meeting is held on an MCU or bridge via video. Although implementation through videoconference (e.g., multimedia conference) is primarily discussed for simplicity, the disclosed techniques may be similarly applied to audio conferencing and other conferencing which may comprise communication between endpoints having a combination of content comprising video, audio, text, graphics, still images, animation, and interactivity, etc . . . Thus, as used herein, videoconference may, for example, include endpoints which have audio and visual capabilities.

FIG. 2 shows the relationship between the virtual breakout rooms 210a and 210b and the main session 200. All participants 213, 215, and 218 are initially participants 215 of the main videoconference session 200. As needed, breakout rooms, for example, 210a and 210b can be generated. The breakout rooms may be generated in a number of ways. For example, the breakout rooms can be generated prior to the breakout session by the chairperson or can be generated on-the-fly by participants as needed. Breakout room 210a may comprise participants 218, who were former participants 215. Likewise, breakout room 210b may comprise participants 213, who were formerly participants 215. The breakout room can be considered to be part of the main videoconference meeting or call. The implementation of this system can hide the breakout call from the outside world such that the main videoconference meeting is not seen as multiple MCU or bridge instances from the outside world. In addition, any breakout room video numbers can be hidden from the outside world such that meeting participants must first enter the main meeting prior to entering a breakout session. In other words, videoconference participants 213, 215, and 218 can call in to the videoconference using a single designator (e.g., call-in number) 310 as shown in FIG. 3.

As shown in FIG. 2 and FIG. 3, a main meeting number 310 can be associated with the main videoconference session 200. All participants 213, 215, and 218 can join the main session 200 by use (e.g., dialing in) of the main meeting number 310. As separate breakout rooms are needed, breakout rooms 210a and 210b, for example, can be generated. It should be noted that numerous breakout rooms are contemplated although FIG. 2 illustrates the use of two breakout rooms for simplicity. Separate videoconference numbers 320a and 320b may be used for the separate breakout sessions 210a and 210b. The nature of the videoconference will generally determine the need and size of breakout rooms.

The separate breakout room numbers 320-a-320n may be transparent and need not be displayed to the participants 213, 215, or 218. This can act to simulate a breakout session such as one performed in a live face-to-face meeting. Transparent breakout room numbers 320-a-320n can also serve as a security feature by preventing would-be outside participants 250 from joining a breakout session without first joining the main videoconference session 200. Breakout rooms 320-a-320n are shown as simple extensions of the main calling room 310. In one embodiment, sequential video numbers may be assigned to each breakout room. The sequential breakout room numbers can be hidden from the outside world such that the main meeting video number 310 is preserved and an outside participant 250, as discussed previously, is unable to jump into a breakout room directly without first entering the main meeting.

The main meeting system can be used to manage the breakout room dialing and configuration. This model is based off of the existing multi-way call model with the extension that the main meeting room can automatically dial up a new breakout room video call from a pre-defined list of video numbers. Breakout room numbers 320-a-320n, although shown in FIG. 3 as having sequential numbers, may use a variety of methods to implement the breakout room. For example, unique video numbers can be used, a dedicated MCU-like audio/video routing can be used, or any other similar mechanism. Thus, a chairperson or administrator can add as many rooms as needed without significant system modification.

Implementation of this feature can be accomplished via leveraging existing MCU or bridge capabilities. Individual breakout rooms associated with consecutively assigned video numbers may be managed by the system administrator. Thus, entering a breakout room can be accomplished by establishing a separate multi-way call and transferring the participant to the new call. Another method of implementing this system is to provide a mechanism that separates the breakout room participants from the main session and route their audio and/or video to a separate multi-way call instance.

FIG. 4 illustrates a video and User Interface (UI) display available to a user for selecting a breakout room. A set of breakout rooms 210 and 220 can be available to a video endpoint 180. Participating endpoints 180 can use a UI 410 or UI 420 to select a breakout room to enter. After selecting one of the breakout rooms 210, their video call can be transferred to the corresponding breakout room and a breakout conversation can be held. This method can be used as a participant-initiated breakout room or to initiate a “private” breakout room as discussed further below.

The main virtual meeting room display 450 can have a global messaging system that audio/video or text messages can be sent to one or more of the breakout rooms to call participants back to the main meeting. The chairperson or presenter may have a selection 430 on their UI for sending a message to all breakout room participants 213 and 218.

FIG. 5 illustrates the UI 500 as would be seen by a breakout room participant 213 or 218. A breakout room display 550 may also include Picture-In-Picture (PIP) video 520 of the main breakout room 200. The PIP window region can appear if, for example, the presenter were to send an audio/video message. This PIP can be two-way or can be one-way video to preserve the privacy of the breakout room participants. Additionally, audio from the main breakout room may be sent to individual breakout rooms. Such audio may also be one-way to preserve privacy. One-way or two-way audio can also be sent.

Two-way audio can be sent at an attenuated level such that the breakout room participants 213 and 218 may be readily heard within a breakout room while engaging in a conversation, but audio from the main conference room will be heard when the breakout conversation momentarily subsides. Additionally, the chairperson of the main videoconference may control the volume of the audio coming from the main videoconference 200 such that, for example, an important announcement from the main videoconference session may be distributed to the breakout rooms by interrupting the breakout room conversation. This may be accomplished by sending audio from the main videoconference 200 to the breakout rooms 210a and 210b at a regular volume while attenuating the audio from the breakout room participants 213 and 218. In another embodiment, the audio from the main videoconference can be amplified above the level of the participants 213 and 218.

A breakout room may also be designated as a “private” breakout room by the breakout room participants. If a breakout room is designated as private, an annunciator (not shown) can be displayed in the breakout room display 550 so that participants may be assured that their conversation is private. Additionally, an indicator may also be manifested on the chairperson's display 450 indicating that a particular breakout room has been designated as private. This feature may be useful when the main videoconference 200 is a negotiation or arbitration. Participants may wish to have a private “sidebar” to discuss strategy, confidential pricing, or any other confidential or privileged information. The system can automatically lock-out any other participants from joining the breakout room once it is designated as private. Additionally, the MCU may limit video and audio to one-way into the breakout room while it is designated as a private breakout room to ensure the privacy of the conversation.

A text area associated with a global text message 540 may be used to show a message from the chairperson. For example, the chairperson may use the “notify all” selection 430 as described above, and send a text message 540 to participants of the breakout rooms to notify them that is it time to return to the main session 200. When not directly or automatically controlled by another return mechanism (e.g., a timer described below), a breakout room UI selection 510 allows breakout room participants 213 and 218 to return themselves to the main videoconference 200.

The previously described embodiment uses a text message 540 for notification to breakout room participants 213 and 218 that it is time to return to the main videoconference 200. Other embodiments utilizing different types of notification systems and return mechanisms are disclosed.

In educational settings, for example, or other settings where the duration of the breakout session needs to be limited to a set amount of time, a timer can be used to transition all breakout room participants to the main meeting after a set period of time has elapsed. In this embodiment, a countdown timer (not shown) can be set by the chairperson. The timer, for example, can be a software or firmware timer controlled by the MCU 150. The display of the timer countdown can be shown in each breakout session display, for example, in the same manner as text message 540 is shown. Participants will thus have continuous notice of how much time is left in the breakout session. At the end of a breakout session, a final message may be displayed to ask breakout participants 213 and 218 to return to the main videoconference 200.

Alternatively, breakout participants 213 and 218 may be returned automatically to the main videoconference 200 when the timer expires. This is particularly useful in settings where pace of the main videoconference is important. This method may also be used in an examination setting where breakout participants 213 and 218 are students working collaboratively on a timed exam or a portion of a timed exam. There are other practical uses for the automatic return feature. For example, in an educational setting, a breakout room or multiple breakout rooms may be used to isolate an individual student or a group of students from a main video session for purposes of allowing the students who have not taken a previously administered exam to be sequestered from a main classroom session while the main classroom session discusses the exam answers.

Other notification techniques such as audio summoning indicators are also disclosed. For example, a bell or chime similar to one used in a concert hall or at a theater to recall the audience during intermission may be used to notify breakout participants to rejoin the main videoconference. In such an embodiment, the videoconference chairperson can program the “notify all” selection 430 to send the bell or chime audio. Optionally, the bell or chime may be programmed to be automatically sent when a timer expires. This type of audio recall may be preferred when the videoconference has a mix of both audiovisual and audio-only conference participants.

Additionally, a voice message may warn participants that the breakout session will be ending soon or that a breakout session time has expired. In one embodiment, the voice message can be played at certain intervals of time remaining in a breakout session countdown timer. In other words, a voice message may notify participants that a certain number of minutes remain until the end of the breakout session when, for example, fifteen and five minutes remain on the countdown timer.

Also disclosed is assignment of breakout room participants in advance of activating or commencement of the break-out session. As discussed previously, participants may self-assign themselves to a breakout room by selecting from one of a plurality of breakout room choices 410 and 420 as shown in FIG. 4. However, there may be situations where self-assignment is not preferred. These methods for room assignment are discussed here further.

FIG. 6 shows a chairperson control interface display 600 used for generating breakout room assignments. In one embodiment, meeting participants 610-a-610f can be presented to the chairperson control interface display 600 in a list 605. The participant list may include characteristics associated with each participant. Characteristics such as physical endpoint location or company represented may be included in the list. The chairperson can also assign participants in advance of beginning specific breakout rooms based on a drop-down characteristic selector 630. For example, participants from Company A may be assigned to breakout room 620a and participants from Company B assigned to breakout room 620b by selecting “Company ID” as the characteristic selector 630. Characteristics may be based on any number of attributes. Such attributes may be specific to the type of videoconference meeting conducted. For example, in a corporate training session, breakout rooms may be assigned by job function (e.g., engineers in one room, salespersons in another, and support staff in yet another room). The number of rooms generated in this case can be automatically determined by the system from the data characteristics.

The number of breakout rooms may also be limited or chosen by the chairperson. A drop-down selector 640, for example, may designate the number of breakout rooms to be generated. Another method of assignment may be made by manual designation of participants to the chosen number of breakout rooms. For example, this may be performed by dragging and dropping the participant into the desired breakout room. In one embodiment, dragging and dropping the participant 610 into a breakout room 620 designates participants for a later transfer.

At a time for a breakout session to begin, the chairperson may inform participants that they should join their breakout discussions. In the case where breakout rooms are assigned in advance, non-selectable breakout rooms may be shown as “grayed out” leaving only pre-assigned breakout rooms available for selection.

In another embodiment, the chairperson can select an option to send participants to their breakout rooms automatically. In other words, participants need not select a breakout room from a UI, they can be automatically placed in a breakout room by the chairperson. Additionally, the drag and drop function may either serve as a designation for a future breakout session, or the act of dragging and dropping a participant 610 into a breakout room 620 may immediately put participant 610 into the designated breakout room 620.

Assignment of participants to breakout rooms may also be made by initiating a “scramble” mode where the chairperson assigns a maximum number of participants per room and rooms that already have the maximum number of participants assigned may display a “room full” message prompting the participant to choose a room that it not yet filled.

Breakout room assignments may also be made randomly. The chairperson may select an option (not shown) from the chairperson UI to place or designate all of participants 610 into a random room 620. Additionally, a hybrid method can be used. For example, managers may be placed into breakout rooms at random where each breakout room 620 receives a proportionate number of managers. Other participants may then be allowed to choose a breakout room 620 up to a maximum number of participants for each room.

A videoconference chairperson may want to distribute supplementary materials “on the fly” during a breakout session. In one embodiment, the chairperson may designate content to be displayed in all breakout rooms simultaneously. The chairperson may also wish to distribute different materials to different breakout rooms. This may be accomplished by uploading or designating material to be assigned to particular breakout rooms in a manner similar to the assignment of participants to breakout rooms. In other words, a set of documents, pictures, video, audio or other material may be designated to a specific breakout room in advance of the commencement of the breakout session. Revealing the content to the breakout room participants may be accomplished by selecting a UI button (not shown) that reveals pre-assigned content to all of the breakout rooms at the same time. Such content may be displayed directly on to the breakout room display 450, or may be made selectable as a UI button or web link. In situations where it is desired for breakout room participants to be in control of when they view the content, a UI can become available to the breakout room participant once the chairperson designates that content to be delivered to that breakout room. Such content may be made available for download by the participants or may be download protected.

One situation where this will be useful is where content is sent to a “room captain” to discuss the content with other members who cannot see the content. Similarly, the chairperson may designate the content to be specific to an individual in a breakout room. This is useful for exam situations where the breakout room participants are exam takers and the content to be delivered is the exam. The timer discussed above may also be used to begin when the content is revealed and the content automatically removed when the timer expires.

The content can also be displayed during the breakout session at times pre-determined by the chairperson. For example, in a situation where each breakout room is corroborating on a project that is scored or evaluated, the chairperson may wish to display each breakout room's progress in fifteen-minute intervals. In this situation, the chairperson can designate a filename and location through her UI that is uploaded and transmitted to the appropriate breakout room at the interval chosen by the chairperson on her UI. Such files may be updated manually or may be updated automatically by, for example, a program used to collect data from the breakout rooms and perform the evaluation.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The described embodiments comprise different features, not all of which are required in all embodiments of the invention. Some embodiments of the present invention utilize only some of the features or possible combinations of the features. Different combinations of features noted in the described embodiments will occur to persons skilled in the art.

What is claimed is:

1. A method performed by an MCU for controlling a breakout session in a multimedia conference comprising:
establishing a main multimedia conference among a plurality of participants via the MCU;
receiving from a control interface an indication of a number of breakout sessions to be established;
establishing a breakout multimedia conference corresponding to each breakout session;
receiving from the control interface one or more parameters for assigning at least one of the plurality of participants to each of the breakout sessions as breakout session participants; and
transferring each of the at least one of the plurality of participants to the established breakout multimedia conference corresponding to the assigned breakout session.

2. The method of claim 1 further comprising:
receiving from the control interface an indication of when breakout session participants should be summoned to return to the main multimedia conference from the breakout multimedia conference;
summoning the one or more breakout session participants to return to the main multimedia conference by a signal presented in the established multimedia breakout conference; and
transferring each of the breakout session participants back to the main multimedia conference.

3. The method of claim 2 wherein receiving the indication of when breakout session participants should be summoned to return to the main multimedia conference from the breakout multimedia conference comprises a timer for summoning the breakout session participant.

4. The method of claim 2 wherein receiving the indication of when breakout session participants should be summoned to return to the main multimedia conference from the breakout multimedia conference comprises receiving a user interface selection for summoning the breakout session participants to return to the main multimedia conference.

5. The method of claim 2 wherein the signal presented in the established multimedia breakout conference for summoning the one or more breakout session participants to return to the main multimedia conference comprises an audio, textual, or video annunciator for summoning the breakout session participants.

6. The method of claim 2 wherein the signal presented in the established multimedia breakout conference for summoning the one or more breakout session participants to return to the main multimedia conference comprises a timer display.

7. The method of claim 2 wherein the transferring each of the breakout session participants back to the main multimedia conference comprises automatically transferring said breakout session participants after a pre-determined time period following the summoning.

8. The method of claim 2 wherein transferring each of the breakout session participants back to the main multimedia conference comprises receiving a trigger from a user interface manually controllable by the main videoconference chairperson.

9. The method of claim 2 wherein the signal presented in the established multimedia breakout conference summoning the one or more breakout session participants to return to the main multimedia conference comprises a textual message comprising a countdown until the breakout session participants are transferred back to the main multimedia conference.

10. The method of claim 2 wherein the signal presented in the established multimedia breakout conference summoning the one or more breakout session participants to return to the main multimedia conference comprises an audio summoning indicator.

11. The method of claim 1 wherein the one or more parameters for assigning at least one of the plurality of participants to each of the breakout sessions comprises limiting at least one of the breakout multimedia conferences to a maximum number of breakout session participants.

12. The method of claim 1 wherein the one or more parameters for assigning at least one of the plurality of participants to each of the breakout sessions comprises a random selection of participants to join the established breakout multimedia conference.

13. The method of claim 1 wherein the one or more parameters for assigning at least one of the plurality of participants to each of the breakout sessions comprises selecting at least one of the breakout session participants to join the established breakout multimedia conference based on a pre-defined characteristic associated with each participant.

14. The method of claim 13 wherein the pre-defined characteristic associated with each participant for assigning the at least one of the breakout session participants to join the established breakout multimedia conference comprises one or more of:
a gender of participants;
a company identifier;
a job function; and
a physical endpoint location.

15. The method of claim 1 wherein the control interface is presented at a conferencing endpoint dialed into the MCU.

16. The method of claim 1 wherein:
establishing a main multimedia conference among a plurality of participants comprises establishing a primary call-in designator for joining the plurality of participants to the main multimedia conference; and
establishing a breakout multimedia conference corresponding to each breakout session comprises generating a secondary conference call-in designator for each breakout multimedia conference and wherein transferring each of the at least one of the plurality of participants to the established breakout multimedia conference comprises instructing an endpoint associated with the participants to call the secondary conference call-in designator.

17. An MCU for controlling breakout sessions in a multimedia conference, comprising:
one or more network interfaces configured to connect to a plurality of remote endpoints;
a conference controller configured to establish a main multimedia conference session among the plurality of remote endpoints and to establish one or more breakout multimedia conference sessions, wherein said conference controller is further configured to:
receive from a control interface an indication of a number of the breakout multimedia conference sessions to be established and one or more parameters for assigning at least one of the plurality of remote endpoints to each of the breakout multimedia conference sessions; and
transfer one or more of the remote endpoints to an established breakout multimedia conference session.

18. The system of claim 17 wherein:
the conference controller is further configured to send an automated audio signal for summoning at least one of the transferred remote endpoints back to the main multimedia conference session in response to receiving a selection of the control interface.

19. The system of claim 17 wherein the conference controller is further configured to substantially simultaneously transfer a first and a second of the plurality of remote endpoints to the established breakout multimedia conference in accordance with receiving a selection of the control interface.

20. The system of claim 17 wherein the control interface is further configured to direct the conference controller to assign a first of the plurality of remote endpoints from a list of remote endpoints to an established breakout multimedia conference session in response to a dragging and dropping of one of the list of remote endpoints to a designator representing one of the breakout multimedia conference sessions.

21. The system of claim 17 wherein the control interface is further configured to assign a first of the plurality of remote endpoints to one of the breakout multimedia conference sessions in accordance with a random selection of the first of the plurality of remote endpoints from one of the plurality of remote endpoints.

22. The system of claim 17 wherein the control interface is further configured to limit at least one of the breakout multimedia conference sessions to have a maximum number of transferred remote endpoints.

23. A multimedia conferencing endpoint for controlling breakout sessions in a multimedia conference comprising:
a network interface configured to connect to a plurality of remote endpoints directly or via an MCU;
a processing unit coupled to the network interface and configured to send and receive conference content comprising at least video or audio from another of the plurality of remote endpoints;
a display coupled to the processing unit and configured to display a control interface for controlling breakout sessions in the conference and the conference content to a user of the multimedia conferencing endpoint; and
a user input device coupled to the processing unit and configured to receive input data from the user; wherein:
the processing unit is configured to display to the user of the multimedia conferencing endpoint via the display the control interface, the control interface comprising one or more prompts to the user requesting at least a number of breakout sessions to be established and one or more parameters for assigning other conference participants to the breakout sessions.

24. The multimedia conferencing endpoint of claim 23 wherein the control interface for controlling breakout sessions in the conference further comprises one or more prompts to the user requesting one or more of the following parameters for summoning remote users to return from a breakout session to a main conference session:
a time interval;
a textual message; and
an audio summoning indicator.

25. The multimedia conferencing endpoint of claim 23 wherein the control interface for controlling breakout sessions in the conference further comprises one or more prompts to limit at least one of the breakout sessions to a maximum number of participants.

26. The multimedia conferencing endpoint of claim 23 wherein the control interface for controlling breakout sessions in the conference further comprises one or more prompts to load a content from a location and send the content to a first of the breakout sessions at a time designated in the one or more prompts.

27. The multimedia conferencing endpoint of claim 23 wherein the control interface for controlling breakout sessions in the conference further comprises one or more prompts to set or activate a timer for summoning a breakout session participant to return to a main conference session.

28. The multimedia conferencing endpoint of claim 27 wherein the control interface for controlling breakout sessions in the conference further comprises one or more prompts to automatically transfer the breakout session participant back to the main conference session when the timer expires.

29. The multimedia conferencing endpoint of claim 23 wherein the control interface for controlling breakout sessions in the conference further comprises one or more prompts to designate at least one of the breakout sessions as a private session.

30. The multimedia conferencing endpoint of claim 29 wherein the processing unit configured to send and receive conference content comprising at least video or audio from another of the plurality of remote endpoints constrains audio to one-way communication to the private session.

31. The multimedia conferencing endpoint of claim 23 wherein the plurality of remote endpoints are required to first join the conference prior to joining the breakout sessions.

32. The multimedia conferencing endpoint of claim 23 wherein the plurality of remote endpoints are prevented from joining the breakout sessions other than an assigned breakout session.

33. The multimedia conferencing endpoint of claim 23 wherein a primary call-in designator is used for joining the plurality of endpoints to the conference; and the processing unit is further configured to call one or more a secondary call-in designators for establishing the breakout sessions.

34. The multimedia conferencing endpoint of claim 33 wherein the secondary conference call-in designators for establishing the breakout sessions are transparent to the plurality of endpoints.

35. The method of claim 23 wherein at least one of the parameters for assigning other conference participants to the breakout sessions comprises a random number for randomly selecting and connecting at least one of the plurality of remote endpoints to the breakout sessions.
